(19) United States
(12) Patent Application Publication
(10) Pub. No.: US 2026/0180951 A1
(43) Pub. Date: Jun. 25, 2026

(54) VIRTUALLY PATCHING AGAINST VULNERABILITIES OF DOWNSTREAM REAL SERVERS USING AN UPSTREAM FIREWALL

(71) Applicant: Fortinet, Inc., Sunnyvale, CA (US)

(72) Inventor: Oscar Alberto Cifuentes Cortes, Oakville (CA)

(73) Assignee: Fortinet, Inc., Sunnyvale, CA (US)

(21) Appl. No.: 19/000,992

(22) Filed: Dec. 24, 2024

Related U.S. Application Data
(63) Continuation-in-part of application No. 17/219,846, filed on Mar. 31, 2021, now Pat. No. 12,375,479.
Application No. 17/219,846 is a continuation of application No. 17/218,870, filed on Mar. 31, 2021, now Pat. No. 12,301,588.

(51) Int. Cl. H04L 9/40

(52) U.S. Cl. CPC H04L 63/02

(57) ABSTRACT

A group of Real Servers, hosting web applications, are scanned to identify vulnerabilities. A next generation firewall of a gateway device located upstream, can virtually patch downstream Real Servers, according to the identified vulnerabilities associated with the Real Servers to prevent exploits. Virtual patching includes configuration of an Intrusion Prevention System (IPS) signatures. Subsequent data traffic is scanned for the identified vulnerabilities of Real Servers at the next generation firewall of the gateway. Pre-scanned data traffic is received for distribution to the Real Servers, in lieu of an operating system update or patch.

### FIELD OF THE INVENTION

The invention relates generally to computer networks, and more specifically, to virtually patching against vulnerabilities of downstream Real Servers using an upstream firewall.

### BACKGROUND

Enterprise networks can have multiple layers of security to ensure all aspects of distributed network devices are protected. For example, a next generation firewall of a gateway device can scan incoming traffic according to gateway rules, for an enterprise network as a whole. Additional devices located downstream within an enterprise network can also scan income traffic according to another set rules.

Unfortunately, many of the security layers of today's network security systems operate independently, and do not share valuable information with each other. Resource are wasted due to scanning at multiple, uncoordinated locations. Conventional systems could be unnecessarily duplicitous, or more importantly, leave gaps in security coverage. Additionally, many conventional security controls react against an attack instead of preventing it, when a vulnerability is known beforehand.

Therefore, what is needed is a robust technique for a load balancing Application Delivery Control (ADC) server, for virtually patching to protect against vulnerabilities of downstream Real Servers, an upstream firewall, over a security fabric.

### SUMMARY

To meet the above-described needs, methods, computer program products, and systems for load balancing ADC server for virtually patching an upstream firewall to protect against vulnerabilities of downstream Real Servers, over a security fabric.

In one embodiment, a plurality of Real Servers are scanned to identify vulnerabilities. In one embodiment, the Real Servers host web applications. A next generation firewall of a gateway device located upstream, can implement virtual patching, according to the identified vulnerabilities associated with the Real Servers to prevent exploits aimed at the Real Servers. Virtual patching includes configuration of an Intrusion Prevention System (IPS) signatures.

In another embodiment, subsequent data traffic is scanned for the identified vulnerabilities at the next generation firewall of the gateway. Scanned data traffic is received for distribution to the Real Servers. One embodiment load-balances traffic during distribution.

Advantageously, network and network device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for virtually patching against vulnerabilities of downstream Remote Servers, using an upstream firewall, according to some embodiments.

FIG. 2A is a more detailed block diagram illustrating an ADC server of the system of FIG. 1, according to an embodiment.

FIG. 2B is a more detailed block diagram illustrating a gateway server of the system of FIG. 1, according to an embodiment.

FIG. 3 is a sequence diagram illustrating interactions between components of the system of FIG. 1, according to an embodiment.

FIG. 4 is a high-level flow diagram of a method for virtually patching against vulnerabilities of downstream Real Servers using an upstream firewall, from the ADC server, according to an embodiment.

FIG. 5 is a high-level flow diagram of a method for virtually patching, at a gateway device of the system of FIG. 1, for downstream Real Servers, according to an embodiment.

FIG. 6 is a block diagram illustrating an example computing device for the system of FIG. 1, according to an embodiment.

### DETAILED DESCRIPTION

Methods, computer program products, and systems for virtually patching an upstream firewall to protect against vulnerabilities of downstream Real Servers. The following disclosure is limited only for the purpose of conciseness, as one of ordinary skill in the art will recognize additional embodiments given the ones described herein.

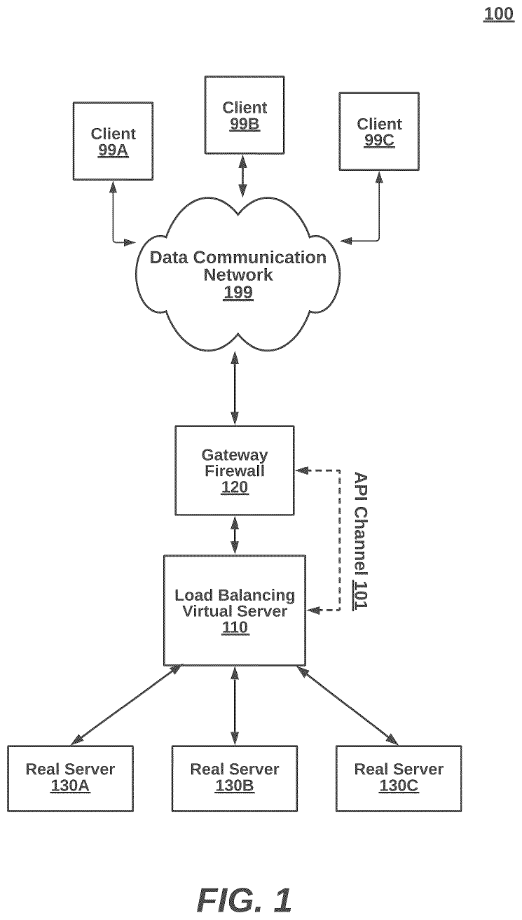

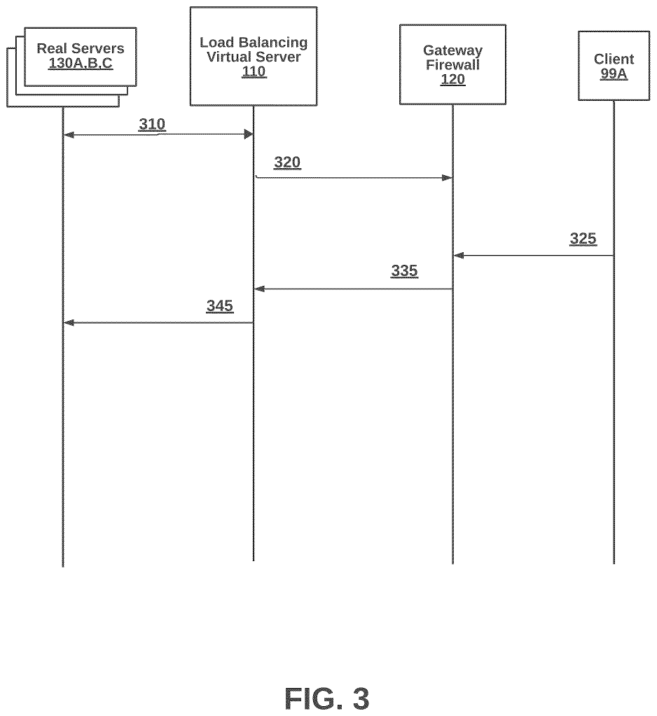

### I. Systems for Automated Upstream Virtual Patching (FIGS. 1-3)

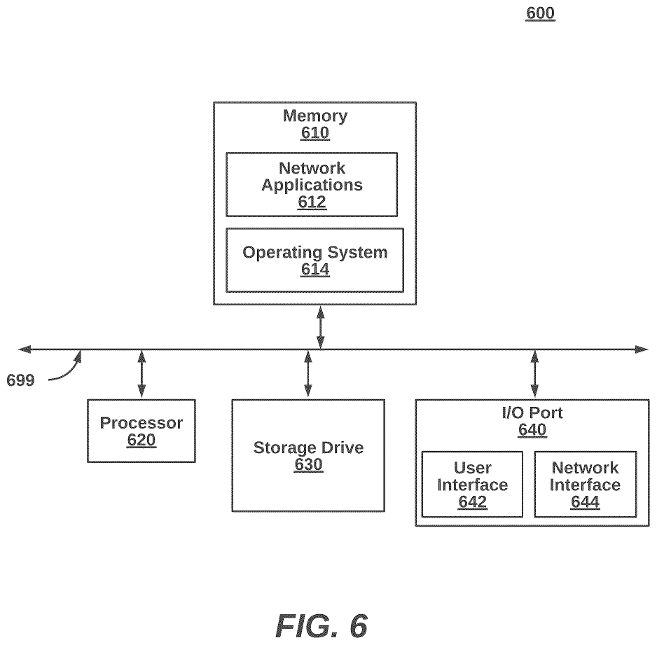

FIG. 1 is a high-level block diagram illustrating a system 100 for virtually patching against vulnerabilities of downstream Remote Servers, using an upstream firewall, according to an embodiment. The system 100 includes a ADC server 110, a gateway 120 and Real Servers 130A-C (collectively). Other embodiments of the system 100 can include additional components that are not shown in FIG. 1, such as additional servers and gateways, along with Wi-Fi controllers, access points, routers and switches. The components of system 100 can be implemented in hardware, software, or a combination of both. An example implementation of processor-based hardware components is shown in FIG. 6.

In one embodiment, components of the system 100 are coupled in communication over a private (or enterprise) network connected to a public network, such as the Internet. In another embodiment, system 100 is an isolated, private network, or alternatively, a set of geographically dispersed LANs. The components can be connected to the data communication system via hard wire (e.g., ADC server 110, gateway device 120, and Real Servers 130A-C). The components can also be connected via wireless networking (e.g., wireless stations and mesh networking nodes). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

The ADC server 110, during load balancing, can use vulnerability scanning data from downstream Real Servers 130A-C to configure the next generation firewall upstream against downstream threats. The virtual patching can be an automatic and dynamic configuration of IPS rules. All of this occurs locally, and without depending upon external services to patch or update the software, or operating system. In one implementation, the ADC server 110 comprises a web application firewall, providing DDoS protection, AV protection, and artificial intelligence threat analytics to identify attack patterns and prioritize threats. The ADC server 110 is positioned in the data path to expose vulnerabilities that are not visible to the gateway device 120. Advantageously, real-time IPS adjustments internally protect the Real Servers 130A-C, without waiting for software updates.

In another implementation, the ADC server 110 ensures optimal performance of web applications to users. To do so, traffic can be intelligently distributed between the Real Servers 130A-C. The specific algorithm for load balancing is implementation specific, and can vary. For example, load balancing can be round robin, weighted, or based on real-time analytics. Moreover, the ADC server 110 can manage user privileges with respect to a specific application. In this case, a streaming video game may provide a premium service to paying subscribers. A video game session can be tracked and moved between Real Servers 130A-C in a manner that is transparent to a player and to a user device of the player.

The ADC server 110 can be a single device, or can be distributed among cooperating devices. In another embodiment, a third-party server provides offloading support from the Internet to local devices.

The gateway device 120 operates upstream from the ADC server 110 to protect the enterprise network, as a whole, as a first line of defense from vulnerabilities. Specifically, incoming, remote data packets, are scanned for potential attacks against data, assets and users on the enterprise network. In one embodiment, the gateway device 120 communicates with the ADC server 110, using application programing interfaces (APIs). In this manner, virtual patching instructions or IPS rules are sent from the ADC server 110 to affect scanning at the gateway device 120. Vulnerability patching can be enabled and disabled from a user interface, accessed by a network administrator. As a result, the enhanced security layers prevent attacks more effectively. In some cases, once Real Servers 130 themselves are updated or patched for protection against novel vulnerabilities that were discovered, the affected vulnerability scanning at the gateway device 120 may again be modified. In some implementations, banned IPs are also shared via APIs, in order to update firewall rules.

The Real Servers 130A-C can host web applications available for clients over the data communication network 199. One implementation includes a single Real Server with multiple virtual servers, each seen as independent by the ADC server 110. Another implementation at a server farm includes hundreds of physical Real Servers.

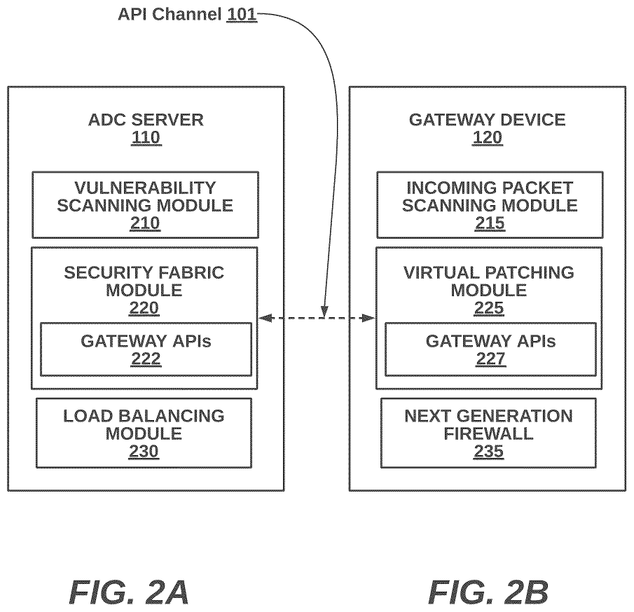

FIG. 2A is a more detailed view of the ADC server 110 of FIG. 1, according to an embodiment. The ADC server 110 further includes a vulnerability scanning module 210, a virtual patching module 220 and a load balancing module 230.

The vulnerability scanning module 210, in an embodiment, scans Real Servers 130A-C to identify vulnerabilities, wherein the Real Servers host web applications. If an HTTP request header violates a rule, the action can be to deny and the attempted session is dropped or the action can be to alert and continue the session. Scanning can also concern an HTTP request body, an HTTP response header or an HTTP response body, as well. Vulnerabilities can be based on a type of operating system, types of applications, versions and patch levels. Example vulnerabilities, without limitation, include SQL injection, cross site scripting, HTTP tampering, cross site request forging, session hacking, request smuggling, web scraping, and the like.

The security fabric module 220 can virtually patch the downstream Real Servers using next generation firewall of the gateway device 120 located upstream, according to the identified vulnerabilities associated with the Real Servers 130A-C. Virtual patching includes configuration of IPS signatures. A vulnerability rules database can be searched with respect to identified vulnerabilities, and further with respect to parameters for a vendor, version, product, and model.

Subsequent data traffic is already scanned for the identified vulnerabilities of Real Servers 130A-Cat the next generation firewall of the gateway device 120. In some embodiments the ADC controller also applies security rules responsive to vulnerabilities.

The load balancing module 230 distributes the subsequent data amongst Real Servers 130A-C, according to a load balancing algorithm. Factors for load balancing can include current server loads, current queue capacity, round robin, weighted round robin, and the like. In one embodiment, health checks are continuously initiated with servers to confirm current availability and discover current network statistics, such as bandwidth, processor load, queue space, and the like.

Turning to FIG. 2B, a more detailed view of the gateway device 120 is set forth. In specific, an incoming packet scanning module 215 scans inbound data traffic according to IPS rules set up by a virtual patching module 225. The security fabric module 220 of the ADC server 110 can use the API channel 101 to communicate with the virtual patching module 225, in a manner conforming with gateway APIs 227. A next generation firewall 235 provides user interface configuration and automatic configuration for governing rule sets.

In one embodiment, the gateway device 120 comprises a physical server blade, and includes an input/output port that allows a wired connection to a laptop device, or alternatively, a wireless connection to the laptop device. This allows a network administrator to directly enable and configure virtual patching. Reports can be automatically generated and emailed to the network administrator.

There are numerous variations to those that are listed herein, that would be apparent to one of ordinary skill in the art, given the disclosure herein.

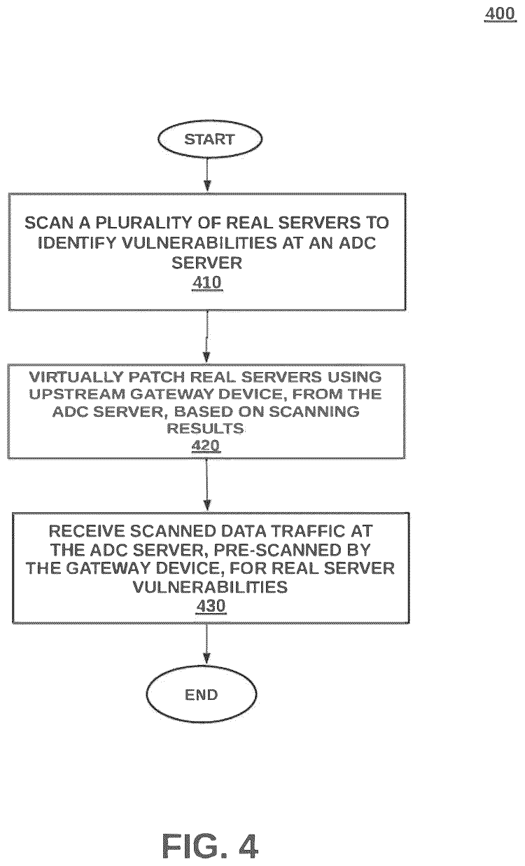

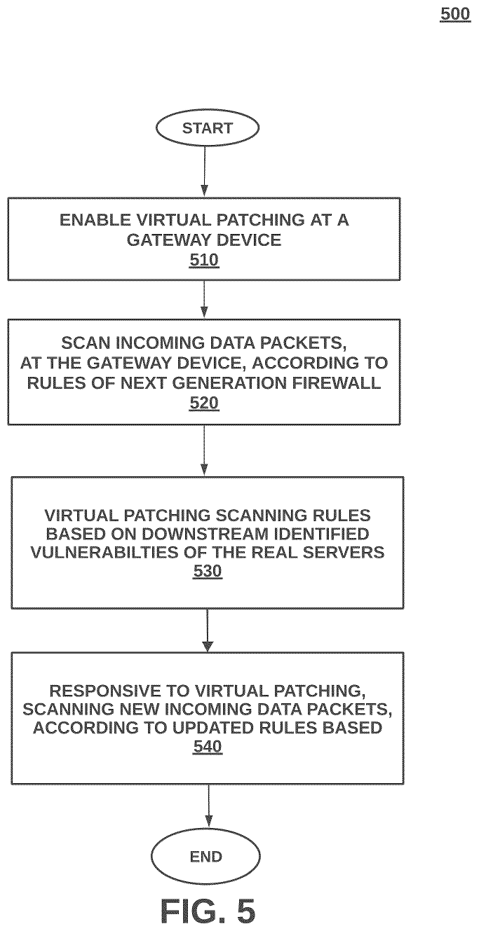

### II. Methods for Automated Upstream Virtual Patching (FIGS. 4-5)

FIG. 4 is a high-level flow diagram of a method 400 for for virtually patching against vulnerabilities of downstream Remote Servers, using an upstream firewall, according to an embodiment. The method 400 can be implemented by, for example, system 100 of FIG. 1. The specific grouping of functionalities and order of steps are a mere example as many other variations of method 500 are possible, within the spirit of the present disclosure. Other variations are possible for different implementations.

At step 410, a plurality of Real Servers are scanned to identify vulnerabilities. The Real Servers host web applications, in one embodiment, and an ADC server manages performance issues, such as user experience with specific applications. Scanning can be invasive using daemons downloaded and installed on the Real servers for direct access, or by designing a set of packets to illicit data. Also, scanning can be passive by snooping and analyzing incoming and outgoing data packets.

At step 420, the next generation firewall of the gateway device located upstream is virtually patched, according to the identified vulnerabilities associated with the Real Servers to prevent exploits aimed at the gateway device. Virtual patching includes configuration of IPS signatures.

Subsequent data traffic is scanned for the identified vulnerabilities at the next generation firewall of the gateway device.

At step 430, scanned data traffic is received for distribution to the Real Servers. The data traffic is pre-scanned by the gateway device, with IPS rules according to the vulnerabilities first identified downstream. The distribution can be load-balanced according to various algorithms.

FIG. 5 is a high-level flow diagram of a method 500 for virtually patching Real Servers, automatically and dynamically, using a next generation firewall, according to an embodiment. At step 510, virtual patching is enabled, and at step 520, incoming data packets are scanned according to rules established by the next generation firewall. At some point, a virtual patch is composed and installed, at step 530, in response to downstream vulnerabilities associated with one or more Real Servers. As a result, new incoming data packets are scanned using IPS rules to cover newly discovered downstream vulnerabilities, at step 540. Optionally, scanning can be further modified responsive to software updates to an ADC server or to one or more Real Servers.

### III. Computing Device for Automated Upstream Virtual Patching (FIG. 6)

FIG. 6 is a block diagram illustrating a computing device 600, for use in the system 100 of FIG. 1 in automatic virtual patching, according to one embodiment. The computing device 600 is a non-limiting example device for implementing each of the components of the system 100, including ADC server 110, gateway device 120, Real Servers 130A-C and clients 99A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98,98, Me, Windows NT, Windows 2000, Windows XP, Windows XP x84Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

I claim:

1. A computer-implemented method in an Application Delivery Control (ADC) server for virtually patching against vulnerabilities of downstream Remote Servers, using an upstream firewall, the method comprising:
scanning the Real Servers to identify vulnerabilities, wherein the Real Servers host web applications;
automatically virtually patching the Real Servers using a next generation firewall of the gateway device located upstream, according to the identified vulnerabilities associated with the Real Servers to prevent exploits, wherein virtual patching includes configuration of an Intrusion Prevention System (IPS) signatures,
wherein subsequent data traffic is scanned for the identified vulnerabilities at the next generation firewall of the gateway; and
receiving scanned data traffic for distribution to the Real Servers, according to a load balancing algorithm.

2. The method of claim 1, further comprising:
installing a software patch to one or more of the Real Servers to address the identified vulnerabilities.

3. The method of claim 2, further comprising:
updating the virtual patching at the gateway, responsive to the software patch coverage of the identified vulnerabilities.

4. The method of claim 1, wherein the step of scanning the Real Servers comprises exposing vulnerabilities that are not visible to the gateway device from upstream.

5. The method of claim 1, wherein the step of virtual patching the next generation firewall for the Real Servers comprises sending data to the gateway device for generating and installing IPS rules.

6. The method of claim 1, wherein the virtual patching comprises using application programming interfaces (APIs) to communicate with gateway device.

7. The method of claim 1, wherein the step of virtual patching the next generation firewall for the Real Servers comprises generating and sending IPS rules to the gateway device for installation.

8. A non-transitory computer-readable medium in a ADC server, on a data communication network, for a load balancing ADC server for virtually patching an upstream firewall to protect against vulnerabilities of downstream Real Servers, the method comprising:
scanning the Real Servers to identify vulnerabilities, wherein the Real Servers host web applications;
virtually patching the Real Servers using a next generation firewall of the gateway device located upstream, according to the identified vulnerabilities associated with the Real Servers to prevent exploits, wherein virtual patching includes configuration of an Intrusion Prevention System (IPS) signatures,
wherein subsequent data traffic is scanned for the identified vulnerabilities at the next generation firewall of the gateway; and
receiving scanned data traffic for distribution to the Real Servers, according to a load balancing algorithm.

9. An Application Delivery Control (ADC) server for virtually patching against vulnerabilities of downstream Remote Servers, using an upstream firewall, the ADC server comprising:
a processor;
a network interface communicatively coupled to the processor and to a data communication network; and
a memory, communicatively coupled to the processor and storing:
a security posture tag module to scanning the Real Servers to identify vulnerabilities, wherein the Real Servers host web applications;
a virtual patching module to automatically, virtually patching the Real Servers using a next generation firewall of the gateway device located upstream, according to the identified vulnerabilities associated with the Real Servers to prevent exploits, according to the identified vulnerabilities associated with the Real Servers to prevent exploits aimed at the gateway device, wherein virtual patching includes configuration of an Intrusion Prevention System (IPS) signatures,
wherein subsequent data traffic is scanned for the identified vulnerabilities at the next generation firewall of the gateway; and
a load balancing module to receive scanned data traffic for distribution to the Real Servers according to a load balancing algorithm.
